(19) United States
(12) Patent Application Publication
(10) Pub. No.: US 2019/0348647 A1
(43) Pub. Date: Nov. 14, 2019

(54) SECONDARY BATTERY

(71) Applicant: Murata Manufacturing Co., Ltd., Nagaokakyo-shi (JP)

(72) Inventors: Toru Kawai, Nagaokakyo-shi (JP); Masahiro Otsuka, Nagaokakyo-shi (JP)

(21) Appl. No.: 16/524,611

(22) Filed: Jul. 29, 2019

Related U.S. Application Data
(63) Continuation of application No. PCT/JP2018/007536, filed on Feb. 28, 2018.

(30) Foreign Application Priority Data
Mar. 31, 2017 (JP) 2017-072431

(51) Int. Cl. H01M 2/10

(52) U.S. Cl. CPC H01M 2/1061; H01M 2220/30

(57) ABSTRACT

A secondary battery that includes an exterior body defining an interior space; an electrode assembly within the interior space of the exterior body, the electrode assembly including a positive electrode, a negative electrode, and a separator between the positive electrode and the negative electrode; and an electrolyte within the interior space of the exterior body, where at least one of the exterior body and the electrode assembly includes a surface that defines an adhesive layer recessed part.

### CROSS REFERENCE TO RELATED APPLICATIONS

The present application is a continuation of International application No. PCT/JP2018/007536, filed Feb. 28, 2018, which claims priority to Japanese Patent Application No. 2017-072431, filed Mar. 31, 2017, the entire contents of each of which are incorporated herein by reference.

### FIELD OF THE INVENTION

The present invention relates to a secondary battery.

### BACKGROUND OF THE INVENTION

Conventionally, secondary batteries have been used as power supplies for various electronic devices. The secondary battery generally has a structure in which an electrode assembly (electrode body) and an electrolyte are accommodated in an exterior body (case), and further includes an external terminal for achieving the electrical connection of the secondary battery.

In recent years, thickness reduction and downsizing of electronic devices have proceeded, and accordingly, thickness reduction and downsizing of the secondary batteries have been increasingly desired. Under such circumstances, attempts have been made to provide a secondary battery with a level difference part which conforms to the internal shape of an electronic device to reduce a dead space caused by the internal shape of the electronic device (Patent Document 1).

Patent Document 1: National Publication of International Patent Application No. 2014-523629

### SUMMARY OF THE INVENTION

The present inventors have found a new problem that, even when a secondary battery is bonded to a housing by an adhesive layer in an electronic device, a dead space is formed by the adhesive layer between the secondary battery and the housing. Specifically, when a substantially rectangular parallelepiped secondary battery 200 as shown in FIG. 16A is bonded to a housing 210 of an electronic device as shown in FIG. 16B, dead spaces 230 and 231 are formed by an adhesive layer 220 between the secondary battery 200 and the housing 210. A thickness h of the adhesive layer is generally about 30 to 300 μm when the adhesive layer is a double-sided adhesive tape. The formation of the dead space by such an adhesive layer has been conventionally considered to be unavoidable. However, for the inventors attempting to reduce the thickness of the secondary battery by only a few micrometers in order to improve the energy density of the secondary battery, the formation of the dead space caused by the adhesive layer is a new serious problem.

An object of the present invention is to provide a secondary battery in which a dead space caused by an adhesive layer is more sufficiently reduced.

The present invention relates to a secondary battery including: an exterior body defining an interior space; an electrode assembly within the interior space of the exterior body, the electrode assembly including a positive electrode, a negative electrode, and a separator between the positive electrode and the negative electrode; an electrolyte within the interior space of the exterior body, wherein at least one of the exterior body and the electrode assembly includes a surface that defines an adhesive layer recessed part.

According to the secondary battery of the present invention, the dead space caused by the adhesive layer is more sufficiently reduced. For this reason, when the secondary battery of the present invention is used, the space can be more effectively utilized in an electronic device.

### BRIEF EXPLANATION OF THE DRAWINGS

FIG. 1A shows a schematic perspective view of a secondary battery according to a first embodiment of the present invention.

FIG. 1B is a schematic cross-sectional view of the secondary battery in FIG. 1A when a P-P cross section of the secondary battery is viewed in an arrow direction, and the secondary battery includes an adhesive layer.

FIG. 1C is a schematic cross-sectional view of the inside of a housing of an electronic device provided with the secondary battery including the adhesive layer shown in FIG. 1B.

FIG. 2A shows a schematic perspective view of a secondary battery according to a second embodiment of the present invention.

FIG. 2B is a schematic cross-sectional view of the secondary battery in FIG. 2A when a P-P cross section of the secondary battery is viewed in an arrow direction, and the secondary battery includes an adhesive layer.

FIG. 3A shows a schematic perspective view of a secondary battery according to a third embodiment of the present invention.

FIG. 3B is a schematic cross-sectional view of the secondary battery in FIG. 3A when a P-P cross section of the secondary battery is viewed in an arrow direction, and the secondary battery includes an adhesive layer.

FIG. 4A shows a schematic perspective view of a secondary battery according to a fourth embodiment of the present invention.

FIG. 4B is a schematic cross-sectional view of the secondary battery in FIG. 4A when a P-P cross section of the secondary battery is viewed in an arrow direction, and the secondary battery includes an adhesive layer.

FIG. 5A shows a schematic perspective view of a secondary battery according to a fifth embodiment of the present invention.

FIG. 5B is a schematic cross-sectional view of the secondary battery in FIG. 5A when a P-P cross section of the secondary battery is viewed in an arrow direction, and the secondary battery includes an adhesive layer.

FIG. 6A shows a schematic perspective view of a secondary battery according to a sixth embodiment of the present invention.

FIG. 6B is a schematic cross-sectional view of the secondary battery in FIG. 6A when a P-P cross section of the secondary battery is viewed in an arrow direction, and the secondary battery includes an adhesive layer.

FIG. 7A shows a schematic perspective view of a secondary battery according to a seventh embodiment of the present invention.

FIG. 7B is a schematic cross-sectional view of the secondary battery in FIG. 7A when a P-P cross section of the secondary battery is viewed in an arrow direction, and the secondary battery includes an adhesive layer.

FIG. 8A shows a schematic perspective view of a secondary battery according to an eighth embodiment of the present invention.

FIG. 8B is a schematic cross-sectional view of the secondary battery in FIG. 8A when a P-P cross section of the secondary battery is viewed in an arrow direction, and the secondary battery includes an adhesive layer.

FIG. 9A shows a schematic perspective view of a secondary battery according to a ninth embodiment of the present invention.

FIG. 9B is a schematic cross-sectional view of the secondary battery in FIG. 9A when a P-P cross section of the secondary battery is viewed in an arrow direction, and the secondary battery includes an adhesive layer.

FIG. 9C is a schematic cross-sectional view of the inside of a housing of an electronic device provided with the secondary battery including the adhesive layer shown in FIG. 9B.

FIG. 10A shows a schematic perspective view of a secondary battery according to a tenth embodiment of the present invention.

FIG. 10B is a schematic cross-sectional view of the secondary battery in FIG. 10A when a P-P cross section of the secondary battery is viewed in an arrow direction, and the secondary battery includes an adhesive layer.

FIG. 10C is a schematic cross-sectional view of the inside of a housing of an electronic device provided with the secondary battery including the adhesive layer shown in FIG. 10B.

FIG. 11 is a schematic cross-sectional view of an electrode assembly for illustrating an example of a wound structure included in an electrode assembly in a secondary battery of the present invention.

FIG. 12 is a schematic cross-sectional view of an electrode assembly for illustrating an example of a flat stacked structure included in an electrode assembly in a secondary battery of the present invention.

FIG. 13A is a schematic cross-sectional view of an electrode assembly for illustrating an example of an electrode assembly included in a secondary battery of the present invention.

FIG. 13B is a schematic sketch drawing of an uppermost electrode of the electrode assembly in FIG. 13A as viewed from directly above.

FIG. 13C is a schematic sketch drawing of an uppermost electrode of the electrode assembly in FIG. 13A as viewed from directly below.

FIG. 14A is a schematic cross-sectional view of an electrode assembly for illustrating an example of an electrode assembly included in a secondary battery of the present invention.

FIG. 14B is a schematic sketch drawing of an uppermost electrode of the electrode assembly in FIG. 14A as viewed from directly above.

FIG. 14C is a schematic sketch drawing of an uppermost electrode of the electrode assembly in FIG. 14A as viewed from directly below.

FIG. 15A is a schematic cross-sectional view of an electrode assembly for illustrating an example of an electrode assembly included in a secondary battery of the present invention.

FIG. 15B is a schematic sketch drawing of an uppermost electrode of the electrode assembly in FIG. 15A as viewed from directly above.

FIG. 15C is a schematic sketch drawing of an uppermost electrode of the electrode assembly in FIG. 15A as viewed from directly below.

FIG. 16A shows a schematic perspective view of a secondary battery according to a conventional technique.

FIG. 16B is a schematic cross-sectional view of the inside of a housing of an electronic device provided with the secondary battery shown in FIG. 16A using an adhesive layer.

### DETAILED DESCRIPTION OF THE INVENTION

[Secondary Battery]

The present invention provides a secondary battery. In the present specification, the term “secondary battery” refers to a battery which can be repeatedly charged and discharged. Therefore, the “secondary battery” is not excessively limited by its name, and may include, for example, an “electrical storage device” and the like.

Hereinafter, a secondary battery according to the present invention will be described in detail with reference to the drawings showing some embodiments. In the present description, various elements in the drawings are merely shown schematically and exemplarily for the understanding of the present invention, and the appearance and the dimensional ratio and the like may be different from those of an actual secondary battery. The terms “vertical direction”, “horizontal direction”, and “front-back direction” used directly or indirectly in the present description respectively correspond to the vertical direction, the horizontal direction, and the front-back direction in the drawings. Unless otherwise stated, the same reference symbols or symbols denote the same members or the same semantic contents except that the shape is different.

### First to Eighth Embodiments

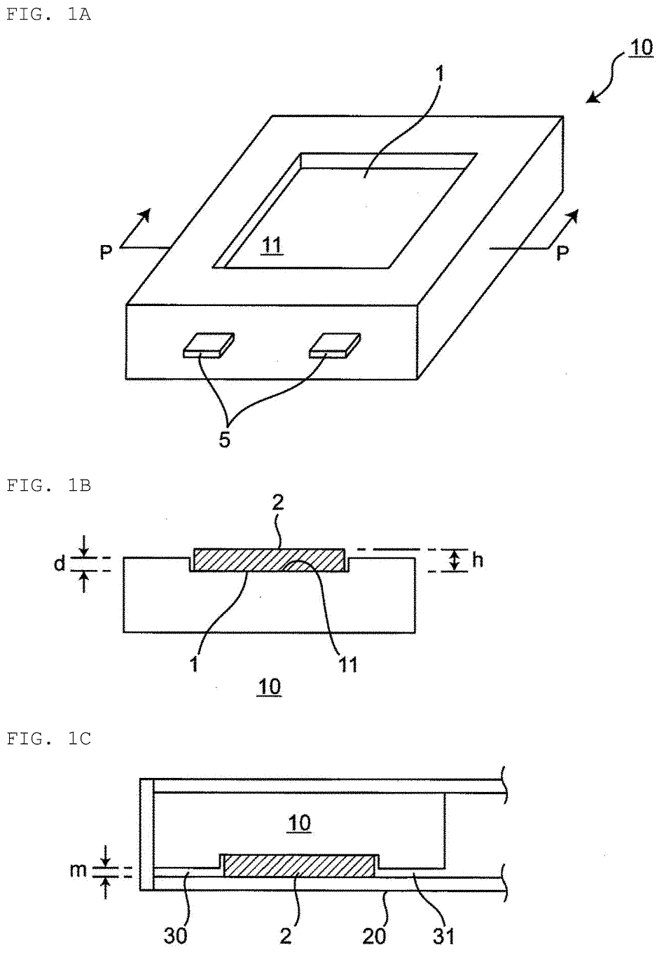

As shown in FIGS. 1A to 8A, a secondary battery 10 according to each of first to eighth embodiments includes a surface in which an adhesive layer recessed part 1 is formed. The adhesive layer recessed part 1 is a recessed part in which an adhesive layer 2 is disposed and accommodated (particularly, at least a bottom surface 11) as shown in FIGS. 1B to 8B. That is, the adhesive layer recessed part 1 is a member (portion) for bonding and fixing the secondary battery to other members via the adhesive layer 2 disposed and accommodated in the adhesive layer recessed part 1. As a result, the adhesive layer 2 is disposed in a portion having a height which is not the highest in the thickness direction of the secondary battery 10. In the first to eighth embodiments, as shown in FIG. 1C, the secondary battery 10 includes the adhesive layer recessed part 1, and the adhesive layer 2 is disposed in the adhesive layer recessed part 1, whereby, as shown in FIG. 1C, a dead space caused by the adhesive layer can be more sufficiently reduced while adhesion and fixation of the secondary battery 10 to other members via the adhesive layer 2 are achieved. Specifically, as shown in FIG. 1C, a distance m between the secondary battery 10 and other member 20 in dead spaces 30, 31 formed by the adhesive layer 2 can be sufficiently reduced as compared with the case where a secondary battery including no adhesive layer recessed part is bonded by an adhesive layer. The other member to which the secondary battery is bonded and fixed is not particularly limited as long as it is a member to which the secondary battery needs to be bonded and fixed when the secondary battery is used. Examples thereof include a housing 20 of an electronic device, particularly the inside of the electronic device. FIGS. 1A to 8A encompass FIGS. 1A, 2A, 3A, 4A, 5A, 6A, 7A and 8A, and respectively show schematic perspective views of secondary batteries according to the first to eighth embodiments. FIGS. 1B to 8B encompass FIGS. 1B, 2B, 3B, 4B, 5B, 6B, 7B and 8B, and are respectively schematic cross-sectional views of the secondary batteries in FIGS. 1A to 8A when P-P cross sections of the secondary batteries are viewed in an arrow direction, and the secondary battery includes an adhesive layer. FIG. 1C is a schematic cross-sectional view of the inside of a housing of an electronic device provided with the secondary battery including the adhesive layer shown in FIG. 1B.

The adhesive layer recessed part 1 generally has a depth smaller than the height (depth) of a so-called level difference part for reducing a dead space caused by the internal shape of the secondary battery. A depth d of the adhesive layer recessed part 1 does not necessarily have to be smaller than a thickness h of the adhesive layer 2, but it is preferably smaller than a thickness h of the adhesive layer 2 from the viewpoint of adhesiveness to the flat surface of other member. This is because the secondary battery can be bonded to other member having a planar shape without any interference. When the secondary battery is bonded to a convex part of the other member, the depth d of the adhesive layer recessed part 1 may be larger than the thickness h of the adhesive layer 2.

The depth d of the adhesive layer recessed part 1 is generally 10 μm to 1 mm, and preferably 20 μm to 500 μm, and more preferably 30 μm to 300 μm, from the viewpoint of the balance between further reduction of the dead space caused by the adhesive layer and further improvement of adhesiveness to the other member.

A difference (h−d) between the thickness h of the adhesive layer 2 and the depth d of the adhesive layer recessed part 1 is preferably 1 μm to 100 μm, and more preferably 5 μm to 50 μm, from the viewpoint of the balance between further reduction of the dead space caused by the adhesive layer and further improvement of adhesiveness to the flat surface of the other member.

The adhesive layer 2 is not particularly limited as long as the adhesion of the secondary battery to the other member can be achieved, and may be, for example, a double-sided tape and an adhesive and the like. In the double-sided tape, an adhesive layer may be formed on at least each of both surfaces of a substrate, and the substrate may be impregnated with the adhesive layer. Examples of a material contained in the substrate of the double-sided tape include, but are not particularly limited to, a polymer and paper. The adhesive layer contained in the double-sided tape may be composed of any known adhesive. An adhesive contained in the adhesive layer 2 may be any known adhesive. The double-sided tape is preferable from the viewpoint of reduction of the dead space due to the adhesive layer.

The thickness h of the adhesive layer 2 is generally 20 μm to 500 μm, and preferably 30 μm to 300 μm from the viewpoint of the balance between the densification of the secondary battery and the adhesiveness of the secondary battery.

A surface in which the adhesive layer recessed part 1 is formed in the secondary battery 10 may be at least one of all surfaces configuring the appearance of the secondary battery 10, and generally, one or two surfaces include an adhesive layer recessed part 1. Preferably, at least one of two surfaces opposed in a thickness direction includes the adhesive layer recessed part 1.

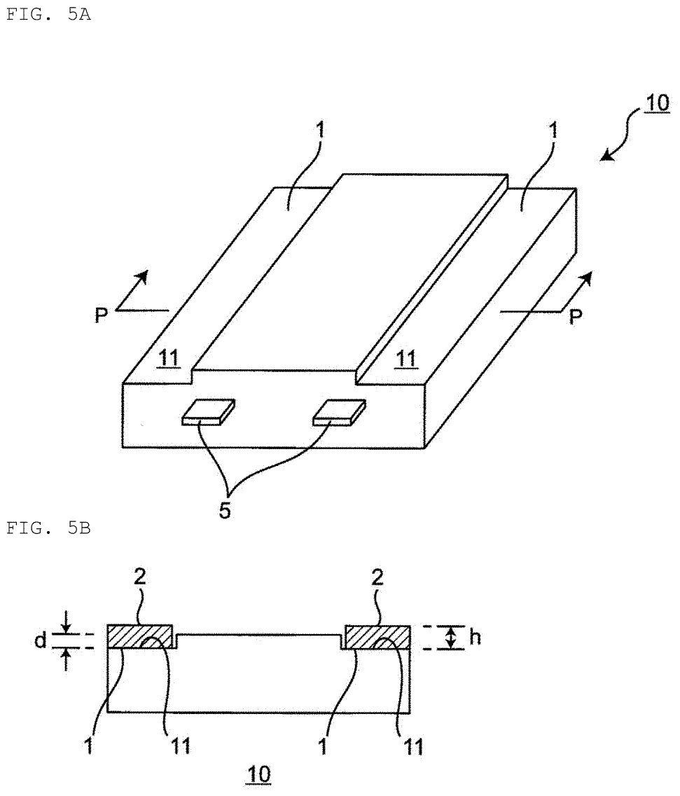

In each surface in which the adhesive layer recessed part 1 is formed in the secondary battery 10, the arrangement of the adhesive layer recessed part 1 is not particularly limited as long as the adhesion of the secondary battery is achieved, and any arrangement is possible. For example, the adhesive layer recessed part 1 may be formed in one integrated region as shown in FIGS. 1A to 4A in each surface in which the adhesive layer recessed part 1 is formed, or the adhesive layer recessed part 1 may be formed in two or more divided regions as shown in FIGS. 5A to 8A. From the viewpoint of the easiness of the adhesion treatment of the secondary battery, it is preferable that the adhesive layer recessed part 1 be formed in one integrated region in each surface in which the adhesive layer recessed part 1 is formed. The one integrated region means a continuous region, and is one continuous region which is not divided.

If the adhesive layer recessed part 1 is formed in one integrated region or in two or more divided regions in each surface in which the adhesive layer recessed part 1 is formed, it is preferable that all formation regions of the adhesive layer recessed part 1 have symmetry (for example, at least one of line symmetry or point symmetry) in each surface. This is because the adhesiveness of the secondary battery is improved. More preferably, all the formation regions of the adhesive layer recessed part 1 have both line symmetry and point symmetry.

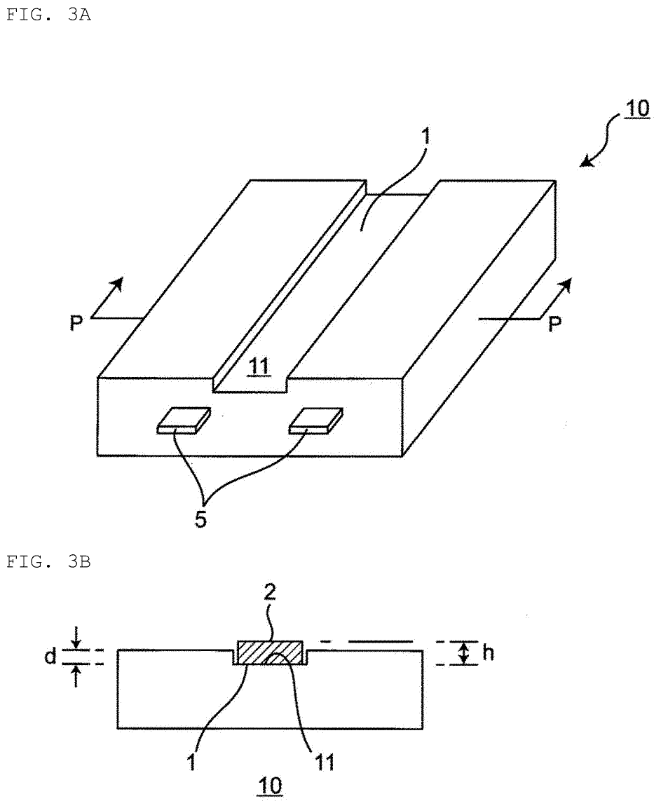

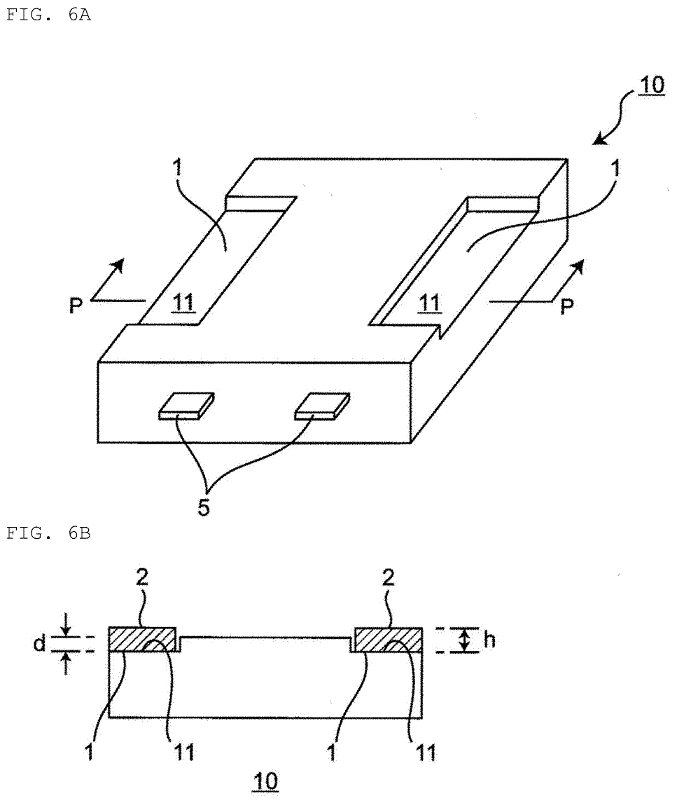

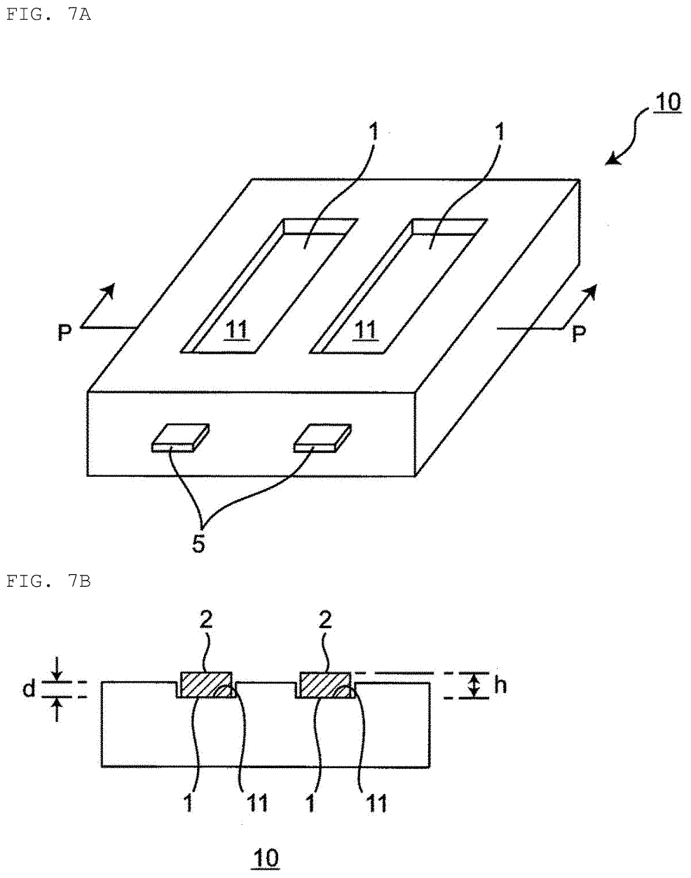

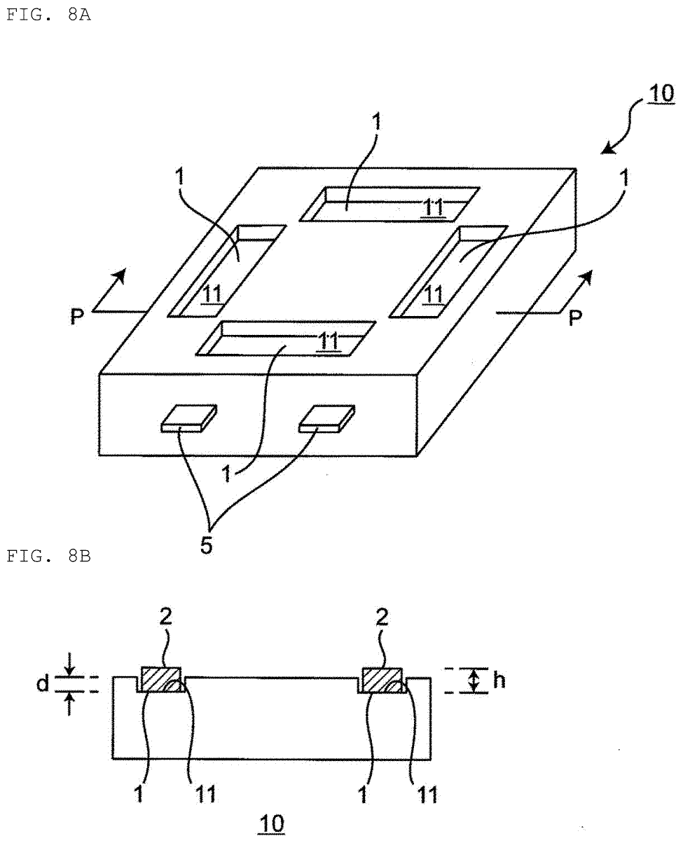

Specifically, for example, in a surface (upper surface) in which the adhesive layer recessed part 1 is formed in the secondary battery 10 shown in each of FIG. 1A, FIG. 3A, FIG. 5A, FIG. 6A, FIG. 7A, and FIG. 8A, one or more formation regions of the adhesive layer recessed part 1 have both line symmetry and point symmetry.

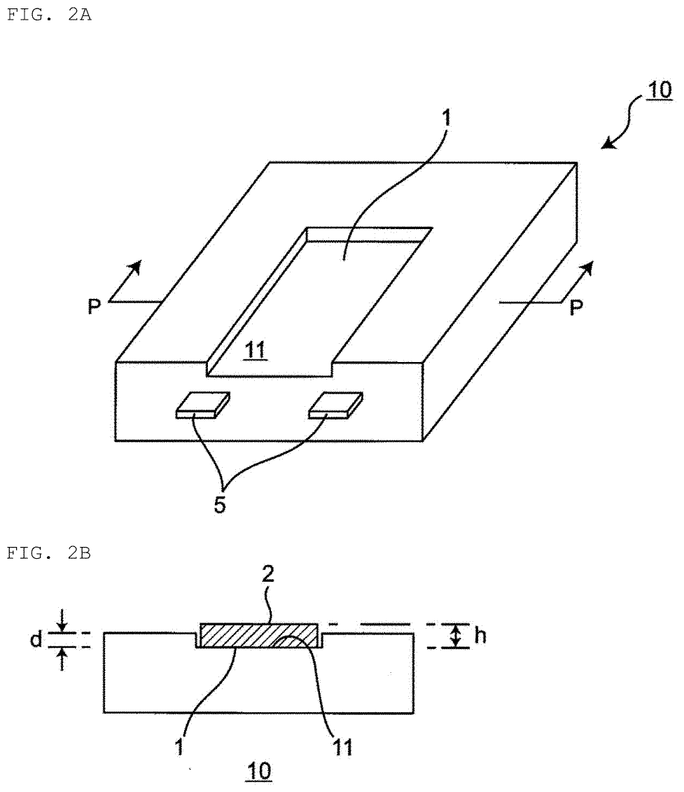

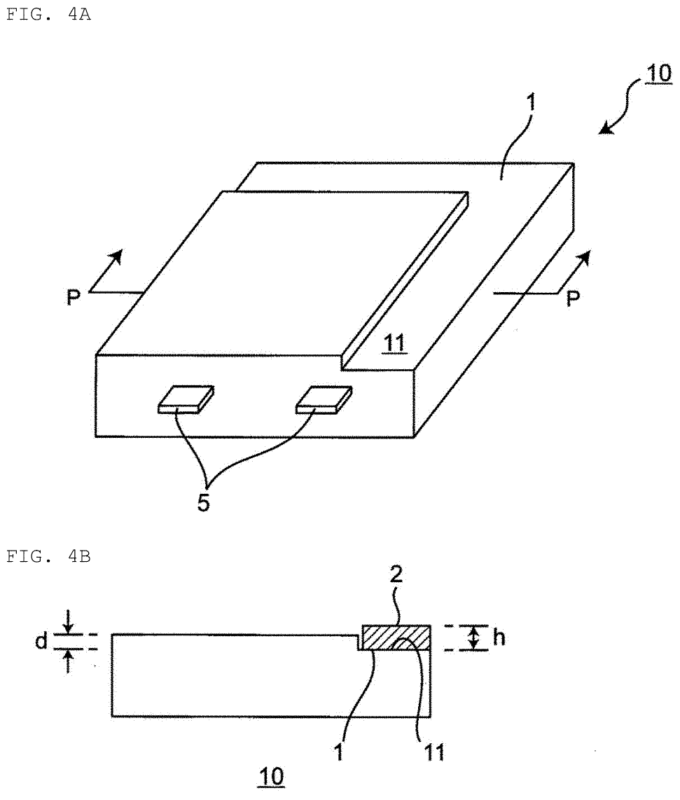

For example, in a surface (upper surface) in which the adhesive layer recessed part 1 is formed in the secondary battery 10 shown in each of FIG. 2A and FIG. 4A, one or more forming regions of the adhesive layer recessed part 1 have line symmetry.

When each surface in which the adhesive layer recessed part is formed is viewed in a direction perpendicular to the surface, the arrangement of a formation region in which the adhesive layer recessed part is formed and a non-formation region in which the adhesive layer recessed part is not formed preferably satisfies the following condition from the viewpoint of further improvement of the balance between the densification of the secondary battery and the adhesiveness of the secondary battery.

The formation region is annularly surrounded by the non-formation region. That is, the non-formation region surrounds the periphery of the formation region to form a closed ring. It is preferable that, when the formation region is divided into two or more, at least one formation region, preferably all the formation regions among the two or more formation regions satisfy the condition.

Specific examples of the arrangement which satisfies such a condition include the arrangement of the formation region and the non-formation region of the adhesive layer recessed part, as shown in FIG. 1A, FIG. 7A, and FIG. 8A.

The formation area (ratio) of the adhesive layer recessed part 1 is not particularly limited as long as the adhesion of the secondary battery is achieved. The formation area is generally 10% to 80% (both inclusive) with respect to the entire area of the surface in which the adhesive layer recessed part 1 is formed, and preferably 15% to 60% (both inclusive), and more preferably 20% to 40% (both inclusive), from the viewpoint of the balance between the densification of the secondary battery and the adhesiveness of the secondary battery. The formation area of the adhesive layer recessed part 1 is an area occupied by the adhesive layer recessed part when the surface of the secondary battery in which the adhesive layer recessed part 1 is formed is viewed from directly above (in a direction perpendicular to the surface). The entire area of the surface in which the adhesive layer recessed part 1 is formed is an entire area when the surface of the secondary battery in which the adhesive layer recessed part 1 is formed is viewed from directly above (in a direction perpendicular to the surface).

### Ninth Embodiment

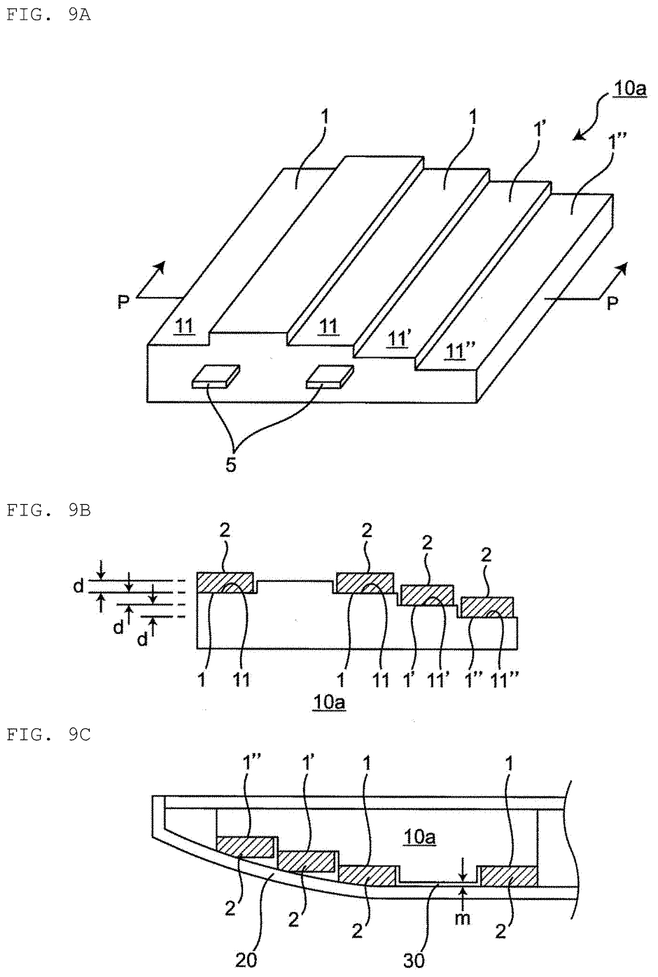

A secondary battery 10a according to a ninth embodiment includes a multi-step adhesive layer recessed part 1′ (1″) as shown in FIG. 9A and FIG. 9B. The adhesive layer recessed part 1 in the first to eighth embodiments described above is a first-step adhesive layer recessed part, and can be referred to as a first adhesive layer recessed part. In the ninth embodiment, the adhesive layer recessed part 1′ is a second-step adhesive layer recessed part formed in the first-step adhesive layer recessed part, and can be referred to as a second adhesive layer recessed part. The adhesive layer recessed part 1″ is a third-step adhesive layer recessed part formed in the second-step adhesive layer recessed part, and can be referred to as a third adhesive layer recessed part. FIG. 9A shows a schematic perspective view of a secondary battery according to a ninth embodiment. FIG. 9B is a schematic cross-sectional view of the secondary battery in FIG. 9A when a P-P cross section of the secondary battery is viewed in an arrow direction, and the secondary battery includes an adhesive layer.

The secondary battery 10a of the ninth embodiment is the same as the secondary battery 10 according to each of the first to eighth embodiments except that the secondary battery 10a includes not only the first adhesive layer recessed part 1 but also the multi-step adhesive layer recessed parts such as the second adhesive layer recessed part 1′ and the third adhesive layer recessed part 1″, and is specifically described below.

As shown in FIG. 9A, the secondary battery 10a according to the ninth embodiment may further include the second adhesive layer recessed part 1′ in the first adhesive layer recessed part 1 while including the first adhesive layer recessed part 1. The third adhesive layer recessed part 1″ may be further included in the second adhesive layer recessed part 1′. In the nth-step adhesive layer recessed part, the (n+1)th-step adhesive layer recessed part may be further included. n is an integer of 2 or more. As shown in FIGS. 9A and 9B, the adhesive layer recessed part 1 is a recessed part for disposing and accommodating the adhesive layer 2 in the adhesive layer recessed part 1 (particularly, at least a bottom surface 11). The adhesive layer recessed part 1′ is a recessed part for disposing and accommodating the adhesive layer 2 in the adhesive layer recessed part 1′ (particularly, at least a bottom surface 11′). The adhesive layer recessed part 1″ is a recessed part for disposing and accommodating the adhesive layer 2 in the adhesive layer recessed part 1″ (particularly, at least a bottom surface 11″).

In the ninth embodiment, the secondary battery 10a includes the multi-step adhesive layer recessed part, whereby the adhesion of the secondary battery 10a to other member having a curved surface shape can be achieved. Specifically, as shown in FIG. 9C, the secondary battery 10a can more sufficiently reduce a dead space 30 caused by the adhesive layers while achieving adhesion to the other member having a curved surface shape (for example, a housing 20 of an electronic device) via the adhesive layer 2 of the multi-step adhesive layer recessed part 1′ and 1″.

In the secondary battery 10a of the ninth embodiment, the depths d of the plurality of adhesive layer recessed parts 1, 1′ and 1″ may be each independently in the same range as that of the depth d of the adhesive layer recessed part in each of the secondary batteries of the first to eighth embodiments described above.

In the secondary battery 10a of the ninth embodiment, the thicknesses h of the plurality of adhesive layers 2 may be each independently in the same range as that of the thickness h of the adhesive layer in each of the secondary batteries of the first to eighth embodiments described above.

In the secondary battery 10a of the ninth embodiment, the relationships (particularly, (h−d)) between the thicknesses h of the adhesive layers in the adhesive layer recessed parts and the depths d of the adhesive layer recessed parts in which the adhesive layers are disposed may be each independently the same as the relationship (particularly, (h−d)) between the thickness h of the adhesive layer and the depth d of the adhesive layer recessed part in which the adhesive layer is disposed in the secondary battery according to each of the first to eighth embodiments described above.

In the ninth embodiment, the formation area (ratio) of the adhesive layer recessed part is the entire formation area (ratio) of the adhesive layer recessed parts including not only the first adhesive layer recessed part 1 but also the multi-step adhesive layer recessed parts such as the second adhesive layer recessed part 1′ and the third adhesive layer recessed part 1″. The entire formation area of the adhesive layer recessed parts may be in the same range as that of each of the first to eighth embodiments with respect to the entire area of the surface in which the adhesive layer recessed parts are formed.

### Tenth Embodiment

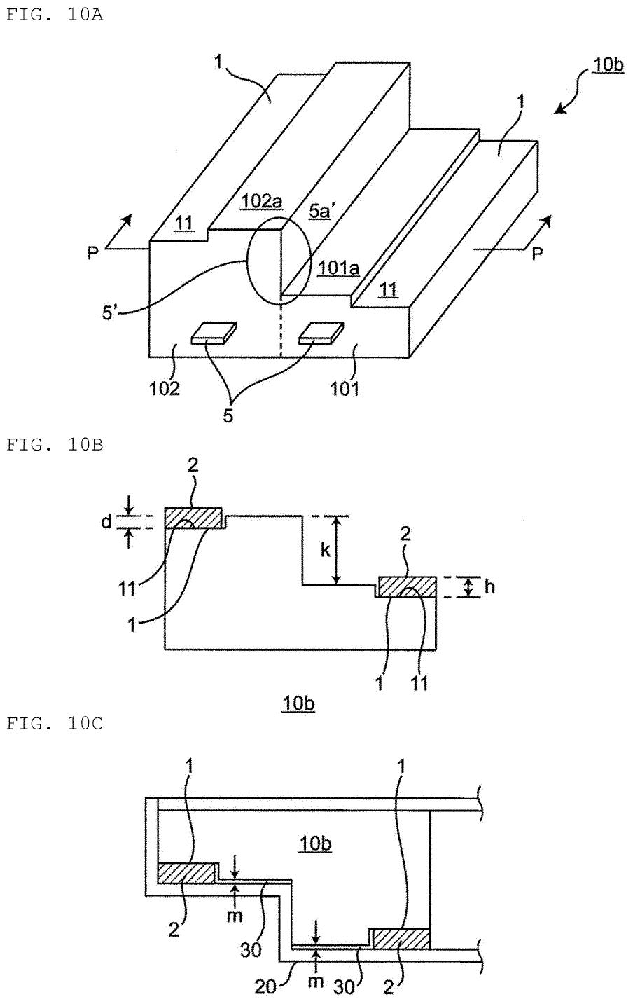

A secondary battery 10b according to the tenth embodiment includes a level difference part 5′ as shown in FIG. 10A and FIG. 10B. The level difference part is a discontinuous portion of an upper surface which is composed of two upper surfaces having different heights in side view and has a height locally changing between the two upper surfaces. A secondary battery includes a level difference part depending on the bonding surface shape (for example, the inner shape of a housing of an electronic device, and the like) of other member to which the secondary battery is bonded, whereby a dead space caused by the bonding surface shape of the other member can be reduced. The side view refers to a state where an object (for example, a secondary battery) is placed and viewed from right beside in the thickness (height) direction of the object, and is in agreement with the side view. The placement is placement in which a surface (flat surface) having a largest area configuring the appearance of an object (for example, a secondary battery) is a bottom surface. The side view also includes perspective side view. That is, the level difference part includes not only a step part in which the height difference of the upper surface can be clearly determined when viewed from right beside as shown in FIG. 10 but also a step part in which the height difference of the upper surface cannot be actually determined when viewed from right beside and which can be determined in perspective view (for example, a step part disposed at the center of the secondary battery in plan view). The level difference part is generally composed of two upper surfaces 101a and 102a having different heights and a side surface 5a′ connecting the two upper surfaces therebetween. Plan view means a state where an object (for example, a secondary battery) is placed and viewed from directly above in the thickness (height) direction, and is in agreement with a plan view. An upper surface means an upper surface when an object (for example, a secondary battery) is placed. FIG. 10A shows a schematic perspective view of a secondary battery according to a tenth embodiment. FIG. 10B is a schematic cross-sectional view of the secondary battery in FIG. 10A when a P-P cross section of the secondary battery is viewed in an arrow direction, and the secondary battery includes an adhesive layer.

The secondary battery 10b according to the tenth embodiment is the same as the secondary battery according to each of the first to eighth embodiments except that the secondary battery 10b includes a level difference part 5′ and is specified below.

In FIG. 10A and FIG. 10B, the secondary battery 10b includes only one level difference part 5′, and includes a low step part 101 including an upper surface having a relatively low height and a high step part 102 including an upper surface having a relatively high height, but the secondary battery 10b may include two or more level difference parts.

In FIG. 10A and FIG. 10B, in the secondary battery 10b, an adhesive layer recessed part 1 is formed in each of both an upper surface 101a of the low step part 101 and an upper surface 102a of the high step part 102, but the adhesive layer recessed part 1 may be formed in the upper surface of at least one step part. From the viewpoint of further improvement of the adhesiveness of the secondary battery, preferably, the adhesive layer recessed part 1 is formed in each of the upper surfaces of all step parts. In the present embodiment, the adhesive layer recessed part 1 may be formed in the upper surface of at least one of two or more step parts (the low step part 101 and the high step part 102 in FIG. 10A) formed by the level difference part.

In the present embodiment, the secondary battery 10b includes the level difference part, and the adhesive layer recessed part 1 is formed in the upper surface of at least one step part formed by the level difference part. Thereby, as shown in FIG. 10C, while the adhesion of the secondary battery 10b to other member (for example, the housing 20 of the electronic device) via the adhesive layer 2 of the adhesive layer recessed part 1 is achieved, not only the dead space due to the bonding surface shape of the other member to which the secondary battery is bonded, but also a dead space 30 (particularly, a distance m between the secondary battery 10b and the other member 20) caused by the adhesive layer can be sufficiently reduced.

In the secondary battery 10b of the tenth embodiment, the depths d of the plurality of adhesive layer recessed part 1 may be each independently in the same range as that of the depth d of the adhesive layer recessed part in the secondary battery according to each of the first to eighth embodiments described above.

In the secondary battery 10b of the tenth embodiment, the thicknesses h of the plurality of adhesive layers 2 may be each independently in the same range as that of the thickness h of the adhesive layer in the secondary battery of each of the first to eighth embodiments described above.

In the secondary battery 10b of the tenth embodiment, the relationships (particularly, (h−d)) between the thicknesses h of the adhesive layers in the adhesive layer recessed parts and the depths d of the adhesive layer recessed parts in which the adhesive layers are disposed may be each independently the same as the relationship (particularly, (h−d)) between the thickness h of the adhesive layer and the depth d of the adhesive layer recessed part in which the adhesive layer is disposed in the secondary battery according to each of the first to eighth embodiments described above.

In the tenth embodiment, the formation area (ratio) of the adhesive layer recessed part 1 may be in the same range as that of the formation area (ratio) of the adhesive layer recessed part 1 in each of the first to eighth embodiments in each step part in which the adhesive layer recessed part is formed. That is, in the tenth embodiment, the formation area (ratio) of the adhesive layer recessed part 1 may be in the same range as that of the formation area (ratio) of the adhesive layer recessed part 1 in the first to eighth embodiments to the entire area of the upper surface in each step part in which the adhesive layer recessed part is formed.

In the present embodiment, in one or more level difference parts included in the secondary battery, the step sizes (level difference) (that is, a height difference between two upper surfaces included in each level difference part) k (see FIG. 10B)) of the level difference parts is generally each independently more than 1 mm and 10 mm or less, and preferably 2 mm or more and 5 mm or less.

### Eleventh Embodiment

An eleventh embodiment is an embodiment including the ninth embodiment and the tenth embodiment. That is, the secondary battery according to the eleventh embodiment includes the multi-step adhesive layer recessed parts such as the first adhesive layer recessed part, the second adhesive layer recessed part 1′ formed in the first adhesive layer recessed part 1, and the third adhesive layer recessed part 1″ formed in the second adhesive layer recessed part 1′ in the upper surface of at least one step part as in the ninth embodiment while including level difference parts as in the tenth embodiment. Thereby, the effects of the ninth embodiment and the effects of the tenth embodiment can be simultaneously obtained. That is, while adhesion to other member having a curved surface shape (for example, a housing 20 of an electronic device) is achieved, the dead space (particularly, the distance m between the secondary battery and the other member) caused by the adhesive layer as well as the dead space due to the bonding surface shape of the other member can be more sufficiently reduced.

### First to Eleventh Embodiments (Common)

In the present invention, the exterior body may be a flexible pouch (soft bag) or a hard case (hard housing). From the viewpoint of further improving the energy density of the secondary battery, the exterior body is preferably a flexible pouch. If the exterior body is the flexible pouch, the exterior body conforms well to the shape of the electrode assembly due to its flexibility by vacuum sealing (reduced pressure sealing), whereby the adhesive layer recessed part can be easily formed.

(Case where Exterior Body is Flexible Pouch)

When the exterior body is a flexible pouch, the flexible pouch is generally formed of a laminate film, and sealing is achieved by heat-sealing a periphery part. As the laminate film, a film obtained by stacking a metal foil and a polymer film is generally used. Specifically, those having a three-layer structure including an outer layer polymer film/metal foil/inner layer polymer film are exemplified. The outer layer polymer film prevents permeation of moisture and the like and damage of the metal foil due to contact and the like, and polymers such as polyamide and polyester can be suitably used. The metal foil prevents permeation of moisture and gas, and foils made of copper, aluminum, and stainless steel and the like can be suitably used. The inner layer polymer film protects the metal foil from the electrolyte stored therein, and is used for melting and sealing during heat sealing. Polyolefin or acid-modified polyolefin can be suitably used. The thickness of the laminate film is not particularly limited, and is preferably, for example, 1 μm or more and 1 mm or less.

When the exterior body is the flexible pouch, the adhesive layer recessed part 1 may generally be derived from the shape of the electrode assembly and/or may be derived from the shape of the exterior body. From the viewpoint of easy formation of the adhesive layer recessed part, the adhesive layer recessed part 1 is preferably derived from the shape of the electrode assembly. The adhesive layer recessed part 1 being derived from the shape of the electrode assembly means that the adhesive layer recessed part 1 (particularly, the depth d thereof) is provided by the shape of the electrode assembly based on the flexibility of the exterior body. The adhesive layer recessed part 1 being derived from the shape of the exterior body means that the adhesive layer recessed part 1 (particularly, the depth d thereof) is provided by the shape of the exterior body, and formed by shaping the exterior body. The shaping method is not particularly limited as long as it can form the adhesive layer recessed part in the laminate film, and examples thereof include a pressing method.

The case where the adhesive layer recessed part 1 is derived from the shape of the electrode assembly includes the case where the adhesive layer recessed part 1 is derived from one or more factors selected from the group consisting of the following factors:

(1) the number of electrodes included in the electrode assembly;

(2) the shape of the electrode included in the electrode assembly; and

(3) the shape of the electrode material layer included in the electrode of the electrode assembly.

(1) The number of electrodes included in the electrode assembly

The adhesive layer recessed part 1 being derived from the number of electrodes included in the electrode assembly means that the depth d of the adhesive layer recessed part 1 is caused by a difference in the number of the electrodes in the thickness direction of the secondary battery between a recessed part corresponding part and a recessed part non-corresponding part in the electrode assembly.

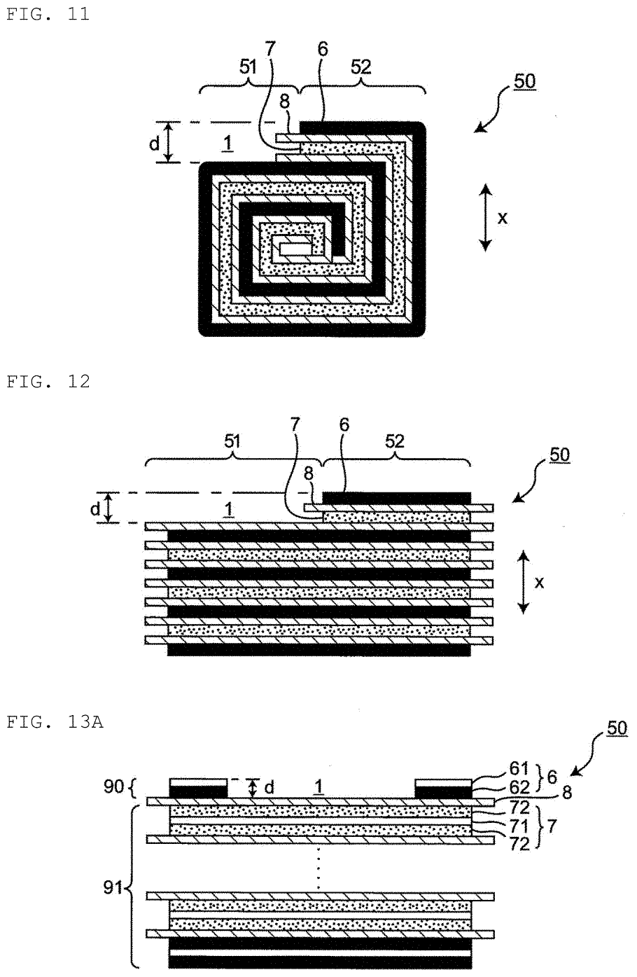

For example, as shown in FIG. 11, when an electrode assembly 50 has a wound structure (jelly-roll type) obtained by winding an electrode unit (electrode configuration layer) including a positive electrode 6, a negative electrode 7 and a separator 8 disposed between the positive electrode 6 and the negative electrode 7 in a roll form, the depth d of the adhesive layer recessed part 1 is caused by a difference in the number of the electrodes (winding number) in a thickness direction x of the secondary battery between a recessed part corresponding part 51 and a recessed part non-corresponding part 52 in the electrode assembly 50. The electrode includes the positive electrode 6 and the negative electrode 7.

For example, as shown in FIG. 12, when the electrode assembly 50 has a planar stacked structure obtained by stacking a plurality of electrode units (electrode configuration layers) including the positive electrode 6, the negative electrode 7, and the separator 8 disposed between the positive electrode 6 and the negative electrode 7 in a planar form, the depth d of the adhesive layer recessed part 1 is caused by a difference in the number of electrodes in the thickness direction x of the secondary battery between the recessed part corresponding part 51 and the recessed part non-corresponding part 52 in the electrode assembly 50. For example, when the electrode assembly has a so-called stack and folding type structure in which the positive electrode, the separator, and the negative electrode are stacked on a long film, and then folded, the depth d of the adhesive layer recessed part is caused by a difference in the number of electrodes (folding number) in the thickness direction x of the secondary battery between the recessed part corresponding part and the recessed part non-corresponding part in the electrode assembly.

(2) Shape of electrode included in electrode assembly

The adhesive layer recessed part 1 being derived from the shape of the electrode included in the electrode assembly means that the depth d of the adhesive layer recessed part 1 is caused by a difference in shape between an outermost electrode and an internal electrode in the electrode assembly.

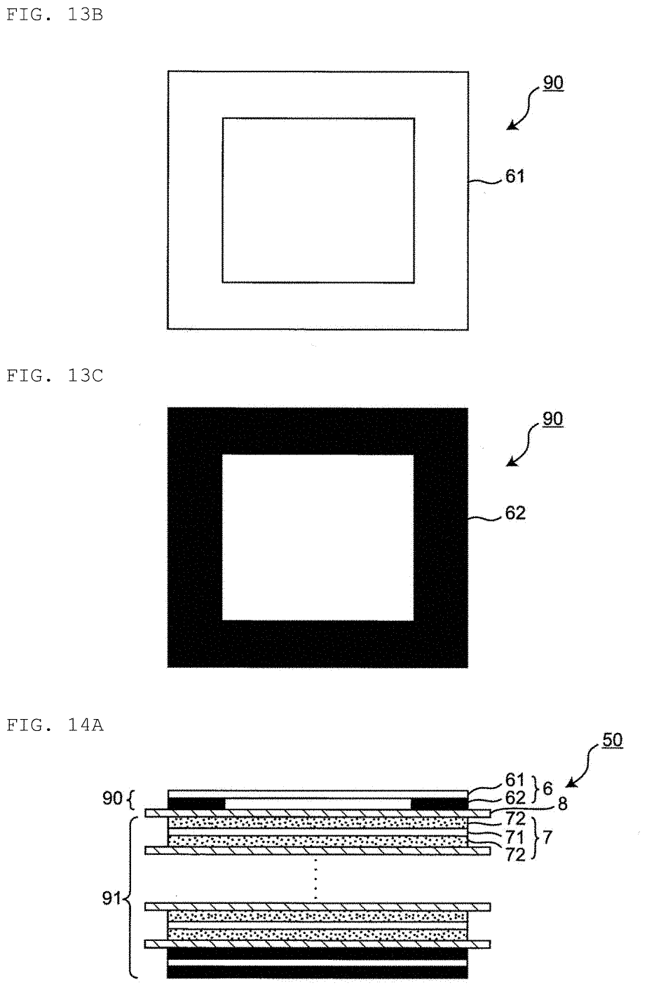

For example, when a secondary electrode 10 shown in FIG. 1A accommodates an electrode assembly 50 having a planar stacked structure as shown in FIG. 13A in an exterior body, the depth d of the adhesive layer recessed part 1 in the electrode assembly 50 is caused by a difference in shape between an outermost electrode (uppermost electrode) 90 and an internal electrode 91. In FIG. 13A, FIG. 13B, and FIG. 13C, the outermost electrode 90 is the positive electrode 6 including a positive electrode material layer 62 provided on one surface of a positive electrode current collector 61, and having a hole. The outermost electrode 90 may be the positive electrode 6 including the positive electrode material layer 62 provided on each of both surfaces of the positive electrode current collector 61, and having a hole. From the viewpoint of reducing the deposition risk of lithium, as shown in FIG. 13A and the like, the outermost electrode 90 is preferably the positive electrode 6 including the positive electrode material layer 62 provided on one surface of the positive electrode current collector 61 and having a hole. In FIG. 13A, the negative electrode 7 of the internal electrode 91 includes a negative electrode material layer 72 provided on each of both surfaces of a negative electrode current collector 71. The positive electrode 6 of the internal electrode 91 includes the positive electrode material layer 62 entirely provided on each of both surfaces of the positive electrode current collector 61. From the viewpoint of further improving the energy density of the secondary battery, as shown in FIGS. 13A, 13B, and 13C, the outermost electrode 90 is preferably a single-sided electrode including an electrode material layer only on one surface of the electrode current collector. When the electrode is the single-sided electrode, the electrode has a hole or a cut as shown in FIG. 13A, FIG. 13B, and FIG. 13C, whereby the effect of preventing the warpage of the single-sided electrode can be obtained. FIG. 13A is a schematic cross-sectional view of an electrode assembly for illustrating an example of an electrode assembly included in a secondary battery of the present invention. FIG. 13B is a schematic sketch drawing of an uppermost electrode of the electrode assembly in FIG. 13A as viewed from directly above. FIG. 13C is a schematic sketch drawing of the uppermost electrode of the electrode assembly in FIG. 13A as viewed from directly below.

(3) Shape of electrode material layer included in electrode of electrode assembly;

The adhesive layer recessed part 1 being derived from the shape of the electrode material layer included in the electrode of the electrode assembly means that the depth d of the adhesive layer recessed part 1 is caused by a difference in shape (coating shape) between the electrode material layer of the outermost electrode and the electrode material layer of the internal electrode in the electrode assembly. The electrode material layer includes a positive electrode material layer and a negative electrode material layer.

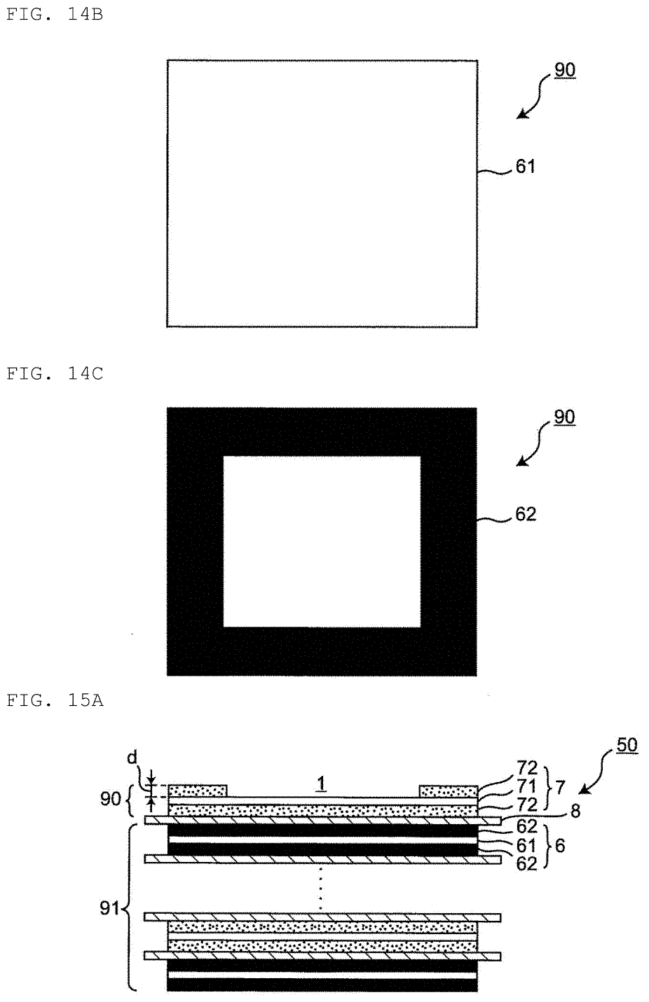

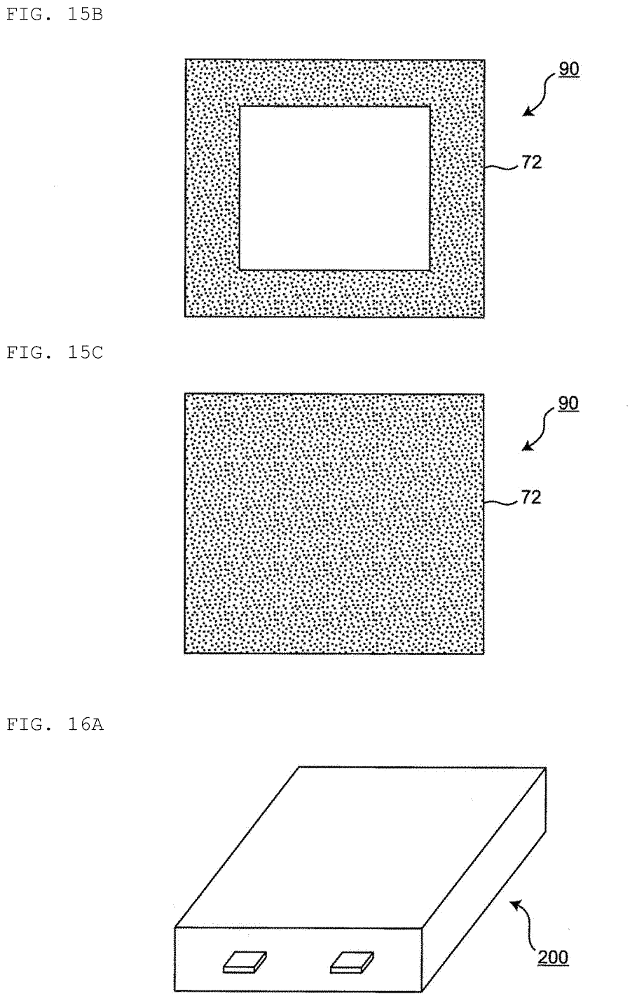

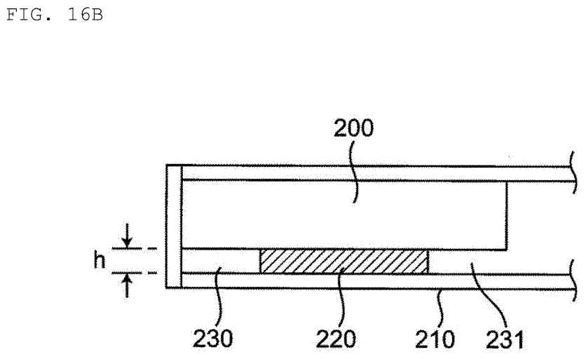

For example, when the secondary electrode 10 shown in FIG. 1A accommodates an electrode assembly 50 having a planar stacked structure as shown in FIG. 14A and FIG. 15A in the exterior body, the depth d of the adhesive layer recessed part 1 in the electrode assembly 50 is caused by a difference in shape (coating shape) between the electrode material layer of the outermost electrode (uppermost electrode) 90 and the electrode material layer of the internal electrode 91. In FIG. 14A, FIG. 14B, and FIG. 14C, the outermost electrode 90 includes the positive electrode material layer 62 partially provided on one surface of the positive electrode current collector 61. In FIG. 14A, a portion where the electrode material layer 62 is not present immediately below the current collector 61 of the outermost electrode 90 is in contact with the separator 8 by its own weight, whereby the adhesive layer recessed part is formed. In FIG. 15A, FIG. 15B, and FIG. 15C, the outermost electrode 90 includes the negative electrode material layer 72 provided on a part of one surface of the negative electrode current collector 71 and the entire other surface. In FIGS. 14A and 15A, the negative electrode 7 of the internal electrode 91 includes the negative electrode material layer 72 entirely provided on each of both surfaces of the negative electrode current collector 71, and the positive electrode 6 of the internal electrode 91 also includes the positive electrode material layer 62 entirely provided on each of both surfaces of the positive electrode current collector 61. Of these embodiments, as shown in FIG. 15A, when the outermost electrode 90 is the negative electrode 7, the deposition of lithium can be more sufficiently prevented. From the viewpoint of further improving the energy density of the secondary battery, the outermost electrode 90 is preferably a single-sided electrode including the electrode material layer provided only on one surface of the electrode current collector as shown in FIGS. 14A, 14B, and 14C. FIG. 14A is a schematic cross-sectional view of an electrode assembly for illustrating an example of an electrode assembly included in a secondary battery of the present invention. FIG. 14B is a schematic sketch drawing of an uppermost electrode of the electrode assembly in FIG. 14A as viewed from directly above. FIG. 14C is a schematic sketch drawing of the uppermost electrode of the electrode assembly in FIG. 14A as viewed from directly below. FIG. 15A is a schematic cross-sectional view of an electrode assembly for illustrating an example of an electrode assembly included in a secondary battery of the present invention. FIG. 15B is a schematic sketch drawing of an uppermost electrode of the electrode assembly in FIG. 15A as viewed from directly above. FIG. 15C is a schematic sketch drawing of the uppermost electrode of the electrode assembly in FIG. 15A as viewed from directly below.

(Case where Exterior Body is Hard Case)

When the exterior body is a hard case, the hard case is generally a metal can, is formed of a metal plate, and sealing is achieved by irradiating a peripheral portion with a laser. As the metal plate, a metal material such as aluminum, nickel, iron, copper, or stainless steel is generally used. The thickness of the metal plate is not particularly limited, and is preferably, for example, 1 μm or more and 1 mm or less.

When the exterior body is the hard case, the adhesive layer recessed part 1 is derived from the shape of the exterior body. That is, the adhesive layer recessed part 1 (particularly, the depth d) is provided by the shape of the exterior body, and is formed by shaping the exterior body. The shaping method is not particularly limited as long as the adhesive layer recessed part can be formed in the hard case, and examples thereof include a pressing method.

When the exterior body is the hard case, the electrode assembly is similar to the electrode assembly when the exterior body is the flexible pouch except that the shape of the electrode assembly, the shape of the electrode included in the electrode assembly, and the shape of the electrode material layer included in the electrode are not particularly limited.

[Constituent Members of Secondary Battery]

The electrode assembly includes a positive electrode 6, a negative electrode 7, and a separator 8, and the positive electrode 6 and the negative electrode 7 are alternately disposed with the separator 8 interposed therebetween. Two external terminals 5 (see FIGS. 1A to 10A) are generally connected to an electrode (the positive electrode or the negative electrode) via a current collecting lead. As a result, the external terminals 5 are led out to the outside. As described above, the electrode assembly may have a flat stacked structure, a wound structure, or a stack and folding type structure.

The positive electrode 6 is composed of at least a positive electrode material layer and a positive electrode current collector (foil), and the positive electrode material layer is partially or entirely provided on one surface or both surfaces of the positive electrode current collector having a desired shape according to the desired shape of the above-described electrode assembly. When the outermost electrode 90 is a positive electrode, the outermost electrode 90 is preferably a positive electrode 6 which includes a positive electrode material layer 62 provided on one surface of a positive electrode current collector 61 as shown in FIG. 13A and the like from the viewpoint of the balance between reduction of the risk of lithium deposition and increase in capacity of the secondary battery, and has a hole. The positive electrode 6 as the internal electrode 91 preferably includes the positive electrode material layer entirely provided on each of both surfaces of the positive electrode current collector, from the viewpoint of further increasing the capacity of the secondary battery. The positive electrode material layer contains a positive electrode active material.

The negative electrode 7 is composed of at least a negative electrode material layer and a negative electrode current collector (foil), and a negative electrode material layer is partially or entirely provided on one surface or both surfaces of the negative electrode current collector having a desired shape according to the desired shape of the above-described electrode assembly. For example, the negative electrode 7 may generally include the negative electrode material layer entirely provided on each of both surfaces of the negative electrode current collector, or may include the negative electrode material layer entirely provided on one surface of the negative electrode current collector. When the outermost electrode 90 is a negative electrode, the outermost electrode 90 is preferably the negative electrode 7 including a negative electrode material layer 72 provided partially on one surface and entirely on the other surface of a negative electrode current collector 71, as shown in FIG. 15A and the like, from the viewpoint of the balance between further reduction of the risk of lithium deposition and increase in capacity of the secondary battery. From the viewpoint of further increasing the capacity of the secondary battery, the negative electrode 7 which is preferable as the internal electrode 91 includes a negative electrode material layer entirely provided on both surfaces of the negative electrode current collector. The negative electrode material layer contains a negative electrode active material.

The positive electrode active material contained in the positive electrode material layer and the negative electrode active material contained in the negative electrode material layer are substances directly involved in the transfer of electrons in the secondary battery and are main substances of the positive and negative electrodes which are responsible for charging and discharging, that is, a battery reaction. More specifically, ions are generated in the electrolyte by the “positive electrode active material contained in the positive electrode material layer” and the “negative electrode active material contained in the negative electrode material layer”, and the ions move between the positive electrode and the negative electrode and the electrons are transferred, whereby charging and discharging are performed. As described later, it is preferable that the positive and negative electrode material layers be particularly layers capable of occluding and releasing lithium ions. That is, a secondary battery is preferable, in which lithium ions move between a positive electrode and a negative electrode via an electrolyte, to charge and discharge the battery. When lithium ions are involved in charging and discharging, the secondary battery according to the present invention corresponds to a so-called “lithium ion battery”.

The positive electrode active material of the positive electrode material layer contains, for example, a granular material, and it is preferable that a binder be contained in the positive electrode material layer in order to maintain a sufficient contact between grains and the shape of the grains. Furthermore, a conductive auxiliary agent is also preferably contained in the positive electrode material layer in order to facilitate transmission of electrons promoting the battery reaction. Similarly, when the negative electrode active material of the negative electrode material layer contains, for example, a granular material, a binder is preferably contained in order to maintain a sufficient contact between grains and the shape of the grains, and a conductive auxiliary agent may be contained in the negative electrode material layer in order to facilitate transmission of electrons promoting the battery reaction. As described above, since a plurality of components are contained, the positive electrode material layer and the negative electrode material layer can also be referred to as “positive electrode mixture layer” and “negative electrode mixture layer”, respectively.

It is preferable that the positive electrode active material be a material contributing to occlusion and release of lithium ions. From these viewpoints, it is preferable that the positive electrode active material be, for example, a lithium-containing composite oxide. More specifically, it is preferable that the positive electrode active material is a lithium transition metal composite oxide which contains lithium and at least one transition metal selected from the group consisting of cobalt, nickel, manganese, and iron. That is, in the positive electrode material layer of the secondary battery according to the present invention, the lithium transition metal composite oxide is preferably contained as the positive electrode active material. For example, the positive electrode active material may be lithium cobaltate, lithium nickelate, lithium manganate, lithium iron phosphate, or materials in which a part of the transition metal of these is substituted with another metal. The positive electrode active material may be contained singly or two or more kinds thereof may be contained in combination. In a more preferred aspect, the positive electrode active material contained in the positive electrode material layer is lithium cobaltate.

The binder which can be contained in the positive electrode material layer is not particularly limited, but examples thereof include at least one selected from the group consisting of polyvinylidene fluoride, a vinylidene fluoride-hexafluoropropylene copolymer, a vinylidene fluoride-tetrafluoroethylene copolymer, and polytetrafluoroethylene and the like. The conductive auxiliary agent which can be contained in the positive electrode material layer is not particularly limited, but examples thereof include at least one selected from the group consisting of carbon blacks such as thermal black, furnace black, channel black, ketjen black, and acetylene black; carbon fibers such as graphite, carbon nanotube, and vapor-grown carbon fiber; metal powders such as copper, nickel, aluminum, and silver; and polyphenylene derivatives. In a more preferred aspect, the binder of the positive electrode material layer is polyvinylidene fluoride, and in another more preferred embodiment, the conductive auxiliary agent of the positive electrode material layer is carbon black. In a still more preferred aspect, the binder and the conductive auxiliary agent in the positive electrode material layer are a combination of polyvinylidene fluoride and carbon black.

It is preferable that the negative electrode active material be a material contributing to occlusion and release of lithium ions. From this viewpoint, as the negative electrode active material, for example, various carbon materials, oxides, or lithium alloys are preferred.

Examples of the various carbon materials for the negative electrode active material include graphite (natural graphite and artificial graphite), hard carbon, soft carbon, and diamond-like carbon. Particularly, graphite is preferred because it has high electron conductivity and excellent adhesiveness to the negative electrode current collector, and the like. Examples of the oxide of the negative electrode active material include at least one selected from the group consisting of silicon oxide, tin oxide, indium oxide, zinc oxide, and lithium oxide and the like. The lithium alloy of the negative electrode active material may be any metal as long as the metal can be alloyed with lithium, and the lithium alloy may be, for example, a binary, ternary or higher alloy of a metal such as Al, Si, Pb, Sn, In, Bi, Ag, Ba, Ca, Hg, Pd, Pt, Te, Zn or La and lithium. It is preferable that the structural form of the oxide be amorphous. This is because degradation due to nonuniformity such as grain boundaries or defects is unlikely to be caused. In a more preferable aspect, the negative electrode active material of the negative electrode material layer is artificial graphite.

The binder which can be contained in the negative electrode material layer is not particularly limited, but examples thereof include at least one kind selected from the group consisting of styrene-butadiene rubber, polyacrylic acid, polyvinylidene fluoride, polyimide-based resin, and polyamideimide-based resin. In a more preferred embodiment, the binder contained in the negative electrode material layer is a styrene-butadiene rubber. The conductive auxiliary agent which can be contained in the negative electrode material layer is not particularly limited, but examples thereof include at least one selected from the group consisting of carbon blacks such as thermal black, furnace black, channel black, ketjen black, and acetylene black; carbon fibers such as graphite, carbon nanotube, and vapor-grown carbon fiber; metal powders such as copper, nickel, aluminum, and silver; and polyphenylene derivatives. The negative electrode material layer may contain a component caused by a thickener component (for example, carboxymethyl cellulose) used at the time of producing the battery.

In a further preferred aspect, the negative electrode active material and the binder in the negative electrode material layer are a combination of artificial graphite and styrene-butadiene rubber.

The positive electrode current collector and the negative electrode current collector used for the positive electrode and the negative electrode are members which contribute to the collection and supply of electrons generated in the active material by the battery reaction. Each of the current collectors may be a sheet-like metal member and may have a porous or perforated form. For example, each of the current collectors may be a metal foil, a punching metal, a net, an expanded metal, and the like. The positive electrode current collector used for the positive electrode preferably contains a metal foil containing at least one selected from the group consisting of aluminum, stainless steel, and nickel and the like, and may be, for example, an aluminum foil. Meanwhile, the negative electrode current collector used for the negative electrode preferably contains a metal foil containing at least one selected from the group consisting of copper, stainless steel, and nickel and the like, and may be, for example, a copper foil.

The separator 8 is a member provided from the viewpoints of the prevention of short circuit due to contact between the positive and negative electrodes and the holding of the electrolyte and the like. In other words, it can be said that the separator is a member which allows ions to pass while preventing electronic contact between the positive and negative electrodes. Preferably, the separator is a porous or microporous insulating member and has a film form due to its small thickness. Although it is merely an example, a microporous membrane made of polyolefin may be used as the separator. In this respect, the microporous membrane used as the separator may contain, for example, only polyethylene (PE) or only polypropylene (PP) as polyolefin. Furthermore, the separator may be a stacked body composed of “a microporous membrane made of PE” and “a microporous membrane made of PP”. The surface of the separator may be covered with inorganic grains and/or an adhesive layer and the like. The surface of the separator may have adhesiveness.

The electrolyte helps the transfer of metal ions released from the electrodes (the positive and negative electrodes). The electrolyte may be a “nonaqueous” electrolyte such as an organic electrolyte or an organic solvent, or may be an “aqueous” electrolyte containing water. The secondary battery of the present invention is preferably a nonaqueous electrolyte secondary battery using an electrolyte containing a “nonaqueous” solvent and a solute as an electrolyte. The electrolyte may have a form such as a liquid form or a gel form (it is to be noted that the nonaqueous electrolyte “in a liquid form” is also referred to herein as a “nonaqueous electrolyte solution”).

As a specific solvent for the nonaqueous electrolyte, a solvent containing at least a carbonate is preferred. The carbonates may be cyclic carbonates and/or chain carbonates. Although not particularly limited, examples of the cyclic carbonates include at least one kind selected from the group consisting of propylene carbonate (PC), ethylene carbonate (EC), butylene carbonate (BC), and vinylene carbonate (VC). Examples of the chain carbonates include at least one kind selected from the group consisting of dimethyl carbonate (DMC), diethyl carbonate (DEC), ethyl methyl carbonate (EMC), and dipropyl carbonate (DPC). In a preferred embodiment of the present invention, a combination of cyclic carbonate and chain carbonate may be used as the nonaqueous electrolyte, and, for example, a mixture of ethylene carbonate and diethyl carbonate is used.

As a solute of a specific nonaqueous electrolyte, for example, an Li salt such as LiPF₆ or LiBF₄ is preferably used.

As the collector lead, it is possible to use any collector lead used in the field of the secondary battery. The collector leads may contain a material which can achieve electron transfer, and generally contain a conductive material such as aluminum, nickel, iron, copper, or stainless steel. The form of the collector lead is not particularly limited, and the form may be, for example, line-shaped or plate-shaped.

As the external terminal 5, it is possible to use any external terminal used in the field of the secondary battery. The external terminals may contain a material which can achieve electron transfer, and generally contain a conductive material such as aluminum, nickel, iron, copper, or stainless steel. The positive electrode external terminal preferably contains aluminum, and the negative electrode external terminal preferably contains copper. The form of the external terminal 5 is not particularly limited, and is generally plate-shaped. The external terminal 5 may be electrically and directly connected to the substrate, or may be electrically and indirectly connected to the substrate with the other device interposed therebetween.

The secondary battery according to the present invention can be used in various fields in which electricity storage is expected. Although the followings are merely examples, the secondary battery according to the present invention, particularly the nonaqueous electrolyte secondary battery can be used in electricity, information and communication fields where electronic devices or mobile devices and the like are used (for example, mobile device fields, such as mobile phones, smart phones, smart watches, laptop computers, digital cameras, active mass meters, arm computers, and electronic paper), domestic and small industrial applications (for example, the fields such as electric tools, golf carts, domestic robots, caregiving robots, and industrial robots), large industrial applications (for example, the fields such as forklifts, elevators, and harbor cranes), transportation system fields (for example, the fields such as hybrid vehicles, electric vehicles, buses, trains, electric assisted bicycles, and two-wheeled electric vehicles), electric power system applications (for example, the fields such as various power generation systems, load conditioners, smart grids, home-installation type power storage systems), IoT applications, and space and deep sea applications (for example, the fields such as spacecraft and research submarines).

Examples of the electronic devices in which the secondary battery according to the present invention is particularly useful include small electronic devices such as mobile phones, smart phones, laptop computers, digital cameras, electronic book terminals, electronic dictionaries, and calculators.

### DESCRIPTION OF REFERENCE SYMBOLS

1: Adhesive layer recessed part (first adhesive layer recessed part)

1′: Second adhesive layer recessed part

1″: Third adhesive layer recessed part

2: Adhesive layer

5: External terminal

6: Positive electrode

7: Negative electrode

8: Separator

10:10a:10b: Secondary battery

11:11′:11″: Bottom surface of adhesive layer recessed part

61: Positive electrode current collector

62: Positive electrode material layer

71: Negative electrode current collector

72: Negative electrode material layer

90: Outermost electrode

91: Internal electrode

1. A secondary battery comprising:
an exterior body defining an interior space;
an electrode assembly within the interior space of the exterior body, the electrode assembly including a positive electrode, a negative electrode, and a separator between the positive electrode and the negative electrode;
an electrolyte within the interior space of the exterior body, wherein
at least one of the exterior body and the electrode assembly includes a surface that defines an adhesive layer recessed part.

2. The secondary battery according to claim 1, further comprising an adhesive layer disposed in the adhesive layer recessed part.

3. The secondary battery according to claim 2, wherein the adhesive layer and the adhesive layer recessed part are configured to adhere the secondary battery to a housing of an electronic device.

4. The secondary battery according to claim 1, wherein the adhesive layer recessed part has a depth of 10 μm to 1 mm.

5. The secondary battery according to claim 2, wherein a depth of the adhesive layer recessed part is smaller than a thickness of the adhesive layer.

6. The secondary battery according to claim 1, wherein the adhesive layer recessed part is derived from a shape of the exterior body.

7. The secondary battery according to claim 6, wherein a shape of the exterior body forms the adhesive layer recessed part.

8. The secondary battery according to claim 7, wherein the exterior body is a metal can.

9. The secondary battery according to claim 1, wherein the adhesive layer recessed part is derived from a shape of the electrode assembly.

10. The secondary battery according to claim 9, wherein a depth of the adhesive layer recessed part is defined by a difference in a number of electrodes in a thickness direction of the secondary battery between a recessed part corresponding part and a recessed part non-corresponding part in the electrode assembly.

11. The secondary battery according to claim 9, wherein a shape of the electrode of the electrode assembly forms the adhesive layer recessed part.

12. The secondary battery according to claim 11, wherein the depth of the adhesive layer recessed part is defined by a difference in shape between an outermost electrode and an internal electrode in the electrode assembly.

13. The secondary battery according to claim 9, wherein a shape of an electrode material layer in the electrode of the electrode assembly defines the adhesive layer recessed part.

14. The secondary battery according to claim 9, wherein the depth of the adhesive layer recessed part is defined by a difference in shape between an electrode material layer of an outermost electrode and an electrode material layer of an internal electrode in the electrode assembly.

15. The secondary battery according to claim 9, wherein the exterior body is a flexible pouch.

16. The secondary battery according to claim 1, wherein the electrode assembly has a planar stacked structure in which a plurality of electrode units including the positive electrode, the negative electrode, and the separator are planarly stacked, or a wound structure in which an electrode unit including the positive electrode, the negative electrode, and the separator is wound into a roll form.

17. The secondary battery according to claim 2, wherein the adhesive layer is a double-sided tape.

18. The secondary battery according to claim 1, wherein the positive electrode and the negative electrode include a layer capable of occluding and releasing lithium ions.

19. The secondary battery according to claim 1, wherein the secondary battery is an electronic device secondary battery.

20. An electronic device, comprising:
the secondary battery according to claim 2; and
a housing to which the secondary battery is bonded via the adhesive layer.
